(19) United States
(12) Patent Application Publication
(10) Pub. No.: US 2026/0011240 A1
(43) Pub. Date: Jan. 8, 2026

(54) GATEWAY FOR A CONTROL SYSTEM

(71) Applicant: Workaround GmbH, München (DE)

(72) Inventors: Adam MUJAJ, München (DE); Simon Armbruster, München (DE); Ashraf Abdalraheem, München (DE); Arthur Crepin-Leblond, München (DE); Till Nöllgen, München (DE); Matthias Kirchner, München (DE)

(21) Appl. No.: 19/256,287

(22) Filed: Jul. 1, 2025

(30) Foreign Application Priority Data
Jul. 2, 2024 (DE) 10 2024 118 768.9

(51) Int. Cl. G08C 17/02; H04W 88/16

(52) U.S. Cl. CPC G08C 17/02; H04W 88/16

(57) ABSTRACT

A gateway for a control system, the gateway including a first wireless communication component a second wireless communication component and/or an Ethernet communication component as well as a RS-232 communication component. The first wireless communication component is configured to establish a first wireless communication link between at least one wearable user device, i.e., a barcode scanner, and the gateway. The second wireless communication component and/or the Ethernet communication component is configured to establish at least one second communication link between the gateway and at least one control unit and the RS-232 communication component is configured to establish a third communication link between the gateway and at least one end device. Further, the gateway is configured to configure at least the RS-232 communication component for establishing the third communication link based on configuration data received via the first communication link.

### TECHNICAL FIELD

The present disclosure relates to gateway for a control system, particularly a logistics control system, to a control system as well as to a method for configuring said control system.

### BACKGROUND

In modern production processes, control units are used to instruct a worker who is carrying out individual process steps of a complex sequence of process steps. For this purpose, user devices, for example barcode scanners, are usually used, by means of which barcodes on components to be assembled or packed are scanned and checked, documented and confirmed by a control unit, for example of an inventory management system.

In this example, to be able to function correctly, the user devices must be registered with a specific task in the control unit so that the control unit can interpret the information originating from the user devices correctly.

Further, it would be desirable to integrate the production system's end devices, such as intelligent storage locations, floor-borne vehicles, production machines and/or the like and in particular actual or planned conditions thereof into the planning of the sequence of process steps. However, the integration may become difficult, as the communication between the end devices and the control systems is not always possible, as the end devices oftentimes are bound to communication interfaces commonly used in the industry.

### SUMMARY

The present disclosure relates to the communication between a control unit and at least one end device, and particularly to a gateway for a control system. The gateway typically serves for assigning multiple wearable user devices to a control unit for allowing a communication. Further, end devices can easily be assigned to the gateway.

According to an aspect of the present disclosure, the gateway includes a first wireless communication component, wherein the first wireless communication component is configured to establish a first communication link between at least one wearable user device and the gateway. The wearable user device includes a barcode scanner. Accordingly, the wearable user device is configured for scanning barcodes, wherein a barcode to be scanned may be a one-dimensional barcode and/or a multi-dimensional barcode, such as a 2D code, a stacked code, a matrix code, a multicolor code, a QR code or the like.

The gateway may allow communication with at least 2, or at least 5, or at least 8, or at least 10 wearable user devices via the first communication link. Even further, the gateway may allow communication with up to 8, or up to 10, or up to 12, or up to 16, or up to 32 wearable user devices via the first communication link. For example, the gateway may be configured to connect between 5 to 10 wearable user devices.

The first communication link is a wireless communication link. For example, the first wireless communication component may be a Bluetooth communication component. Accordingly, the first communication link may be a Bluetooth communication link. In a particular aspect, the Bluetooth communication link may be based on Bluetooth 5.x (e.g. but not limited to Bluetooth 5.2, or Bluetooth 5.3, or Bluetooth 5.4). The Bluetooth communication link may be based on Bluetooth Classic and/or Bluetooth Low Energy (Bluetooth LE).

Further, the gateway includes a second wireless communication component an Ethernet communication component. The second wireless communication component and/or the Ethernet communication component is configured to establish at least one second communication link between the gateway and at least one control unit.

The second wireless communication component may be a Wi-Fi communication component (IEEE 802.11). Accordingly, the second communication link may be a wireless, Wi-Fi communication link. In a particular aspect, the Wi-Fi communication link may be based on but not limited to Wi-Fi 6, Wi-Fi 6E or even Wi-Fi 7.

The Ethernet communication component may be a IEEE 802.3 communication component. The Ethernet communication component allows to establish a LAN communication link. This can be done alternatively or in addition to a wireless second communication link.

The second (wired and/or wireless) communication link serves for connecting the gateway with at least one control unit. In a control system multiple gateways may be connected with a control unit. The control unit may be a central control unit or the system may comprise distributed control units.

Even further, the gateway includes a RS-232 communication component. The RS-232 communication component is configured to establish a third communication link between the gateway and at least one end device. Said third communication link is a wired RS-232 communication link.

RS-232 communication is a serial communication transmission of data. RS-232 is commonly used in computer serial ports and is still widely used in industrial communication devices. Hence, the gateway facilitates communication with end device(s).

Further, with providing a gateway that supports RS-232 communication and at the same time provides for Wi-Fi and/or LAN capabilities, drawbacks of the RS-232 communication, such as limited cable length can be overcome. This is, as a gateway may be connected to the end device, using the third communication link. The gateway may be located close to the end device and may be in communication, using the second communication link, with a control unit. The second communication link (e.g. LAN or WI-FI) allows communication over larger distances. Hence, the control unit may then communicate and control the end device via the gateway

For configuring the RS-232 communication component for establishing the third communication link, the gateway is configured to receive configuration data via the first communication link. Based on the received data, the gateway can configure the RS-232 communication component. It is to be understood, that further components of the gateway may also be configured based on the received configuration data.

Thus, for configuring the gateway, particularly the RS-232 communication component, a wearable user device can be used. This allows for a facilitated configuration.

In a particular example, there may be provided a configuration code, which may be an optically readable code, such as a one-dimensional barcode and/or a multi-dimensional barcode, such as a 2D code, a stacked code, a matrix code, a multicolour code, a QR code or suchlike.

The configuration code can be assigned to a particular end device and may be generated accordingly. A wearable user device may be configured for capturing the configuration code. Based on the configuration code configuration data can be provided. This configuration data can then be transmitted to the gateway, using the first communication link.

The configuration data may be present in the configuration code, and/or the configuration code may include an identifier, ID. The ID may be linked to configuration data. Thus, based on the ID, configuration data can be generated and/or looked up.

Likewise, the transmitted configuration data may include instructions for configuring the gateway, particularly the RS-232 communication component, and/or a further identifier. The identifier may be linked to instructions for configuring the gateway, particularly the RS-232 communication component. Thus, the identifier allows to choose respective instructions. The choice can be done by the gateway and/or a control unit, the gateway is assigned to.

In a further aspect, the second and third communication links are configured to allow for a simultaneous communication between the gateway and the control unit as well as between the gateway and the at least one end device.

The term simultaneously refers to the occurrence of two or more communication actions at the same time. This can involve sending and receiving data across different communication links. In other words, the second communication link is not blocked by third communication link, or vice versa, but second and third communication links can be operated independently from each other. This applies to the first and second communication link as well as to the first and third communication link. This applies likewise to the first and second communication link as well as to the first and third communication link.

The simultaneous communication allows to prevent interferences and provides for a broader bandwidth compared to scenarios, where only a single, e.g. the second communication link, is provided. As the third RS-232 communication link is wired, this communication can be easily shielded and is hence less prone to interferences and provides for a high eavesdropping security. For further enhancing the security level, a crypto and/or authentication module may be assigned to the RS-232 communication module for providing an encrypted RS-232 communication link and/or a respective authentication. Authentication and/or encryption keys may be shared using the configuration data.

In a further aspect, the first wireless communication component (e.g. Bluetooth) and the second wireless communication component (e.g. Wi-Fi) are provided in a single wireless communication element (such as a Wi-Fi/Bluetooth combo chipset, (e.g. a PAN 9019) and/or the like).

The RS-232 communication component may include a RJ12 port, particularly a RJ12 socket, wherein the RJ12 port may be configured for powering the gateway. Thus, wiring is facilitated as a data connection and a power connection can be 5 combined in the RJ12 port and a respective cable (e.g. a RJ12 to DB9-cable).

Further, the RS-232 communication component may include a DB9 port, an RJ45 port and/or the like. Those ports may be configured for powering the gateway. In these cases, a DB9 to DB9-cable or a RJ45 to DB9 cable may be used, respectively.

The Ethernet communication component may include a RJ45 port, particularly a RJ45 socket, wherein the RJ45 port may be configured for powering the gateway. Thus, wiring is facilitated as a data connection and a power connection can be combined in the RJ45 port and a respective cable.

Further, the gateway may include a first gateway module and a second gateway module being in communication with each other. In this case, the first gateway module includes the first wireless communication component, the second wireless communication component and/or the Ethernet communication component and the RS-232 communication component. Hence, the communication modules for establishing the first, second and third communication links are provided on one gateway module, particularly a single PCB. The first gateway module may further include at least one antenna or an antenna port for connecting an antenna. The antenna may be designed for the first wireless communication link and/or the second communication link. In a particular aspect, the antenna may be a multi band antenna allowing e.g. for 2.4 GHZ, 5 GHZ and/or 6 GHz communications.

The second gateway module is a single board computer (SBC), such as a Raspberry Pi, a System on Module (SOM), or the like.

A single board computer is typically a computer built onto a single circuit board, including components such as at least one microprocessor, memory, input/output (I/O), and other components required for a functional computer. SBCs are compact and energy-efficient.

A System on Module (SOM) is a board-level circuit that integrates a system function in a single module. It typically includes a microprocessor, memory, and optionally other components. SoMs typically provide for a small footprint and can e.g. be mounted onto a carrier board using an (application-specific) interface, such as a multi-pin connector.

While the gateway's computing can be done on the second gateway module (e.g. a SBC and/or SoM), the first gateway module allows to extend or replace the communication links natively provided by the SBC/SoM.

In a further aspect, the first gateway module and the second gateway module may be connected via a communication link, particularly a multi-pin connector, and wherein the communication link includes at least one of the following, a SDIO-interface, a UART-interface, an I2C-bus and/or a SPI-interface.

The SDIO interface is a bus-interface for the first gateway module to the second gateway module, particularly a processor thereof. The SDIO interface can be used for exchanging data and may be operated using the UHS-I and/or UHS-II protocol. Here, the second wireless communication component (e.g. Wi-Fi) may be connected via the SDIO-interface with the second gateway module.

The UART interface (universal asynchronous receiver-transmitter (UART)) is a peripheral interface for asynchronous serial communication in which the data format and transmission speeds are configurable. It sends data bits one by one, from the least significant to the most significant, framed by start and stop bits so that precise timing is handled by a communication channel.

In a particular aspect, the first wireless communication component (e.g. Bluetooth) may be connected via the UART-interface with the second gateway module.

The I2C (Inter-Integrated Circuit) bus is a synchronous, multi-controller/multi-target, single-ended, serial communication bus. I2C allows communication based on two pins only, while e.g. SPI requires more pins. I2C may be used for the RS-232 communication component. For example, the RS-232 communication component may be connected via a UART serial device to an I2C-bus. This allows for connecting the second gateway module with an end device, using the third RS-232 communication link.

The Serial Peripheral Interface (SPI) allows for synchronous serial communication. SPI uses a master-slave architecture, where one main device orchestrates communication with some number of peripheral devices. In a particular aspect, the Ethernet communication component may be connected via the SPI-interface with the second gateway module.

The gateway may further include a USB-communication component. The USB-communication component may be configured for receiving gateway configuration data and/or for powering the gateway. Further, the USB-communication component may serve for communicating with at least one end device. Thus, end devices can be connected with the gateway using a RS-232 communication and/or USB.

Further the present disclosure relates to a control system. The control system comprises at least one gateway. The gateway being configured as outlined above. Further, the control system comprises at least one wearable user device.

In a particular aspect, the system may comprise at least 10, or at least 25, or at least 100, or at least 200 gateways, wherein each gateway may be in communication with up to 8, or up to 12, or up to 16, or up to 32 user devices.

The wearable user device includes at least one sensor, such as a camera or a barcode scanner. The sensor is configured to capture at least one configuration code and to transmit configuration data based on the configuration code via the first communication link to the gateway. In a particular aspect, the sensor is a barcode scanner. As outlined above, the configuration data serves for configuring the gateway, particularly the RS-232 communication component.

The configuration code may include configuration data and/or the configuration code may include an identifier, ID. The ID may be linked to configuration data. Thus, based on the ID, configuration data can be generated and/or looked up.

Likewise, the transmitted configuration data may include instructions for configuring the gateway, particularly the RS-232 communication component, and/or a further identifier. The identifier may be linked to instructions for configuring the gateway, particularly the RS-232 communication component. Thus, the identifier allows to choose respective instructions. The choice can be done by the gateway and/or a control unit, the gateway is assigned to.

Further, the control system may include at least one control unit. The control unit may be a central control unit. Alternatively, distributed control units may be provided, which can act commonly.

The control system may further include an end device. The end device may be an intelligent storage location, a floor-borne vehicle, a production machine and/or any other component being used in production or logistics process the control system is assigned to. In a particular aspect, the control unit may control, surveil and/or document the respective production or logistics process.

The control unit may include a TCP (Transmission Control Protocol) server, a MQTT (Message Queuing Telemetry Transport) server and may be cloud based. The end device may include a TCP server or a MQTT server.

In a particular aspect, the wearable user device may be attached to a garment (such as a glove, a cuff, glasses, and/or the like). The attachment may be achieved using a holder, which allows for a detachable attachment of the wearable user device. In this way, the user device can be worn by the user or worker particularly easily.

Even further, the first communication link, i.e. the communication link between the gateway and the at least one wearable user device may be a Bluetooth communication link. In a particular aspect, the Bluetooth communication link may be based on Blue-tooth 5.x (e.g. but not limited to Bluetooth 5.2, or Bluetooth 5.3, or Bluetooth 5.4). The Bluetooth communication link may be based on Bluetooth Classic and/or Bluetooth Low Energy (Bluetooth LE).

Even further, the gateway may be configured to connect at least two wearable user devices, or at least five wearable user devices, or at least eight wearable user devices, or at least 10 wearable user devices. Hence, the gateway may communicate, using the first communication link with multiple wearable user devices. Even further, the gateway may allow communication with up to 8, or up to 10, or up to 12, or up to 16, or up to 32 wearable user devices via the first communication link. For example, the gateway may be configured to connect between 5 to 10 wearable user devices. For example, the gateway may be configured to connect between 5 to 10 wearable user devices.

Further, the present disclosure relates to a method for configuring a control system, wherein the control system is configured as outline above. The method includes the following:
a) providing at least one configuration code (e.g. an optical readable code, such as a barcode), wherein providing the at least one configuration code optionally includes generating the configuration code;
b) capturing the configuration code with a wearable user device, which wearable user device is assigned to a gateway;
c) transmitting configuration data based on the configuration code from the wearable user device to the assigned gateway;
d) receiving the configuration data and configuring the RS-232 communication component of the gateway based on the received configuration data;
e) establishing a third communication link between the gateway and at least one end device for operating the control system.

### BRIEF DESCRIPTION OF THE FIGURES

Further features and advantages will be apparent from the following description of exemplary embodiments, which are not to be understood as limiting, as well as the accompanying figures, to which reference is made. In the figures:

FIG. 1 shows schematically a block diagram of a gateway;

FIG. 2 shows schematically in isometric view of a gateway;

FIG. 3 shows schematically a control system;

FIG. 4 shows schematically a further control system, and

FIG. 5 shows a schematic flow chart of a method.

### DETAILED DESCRIPTION

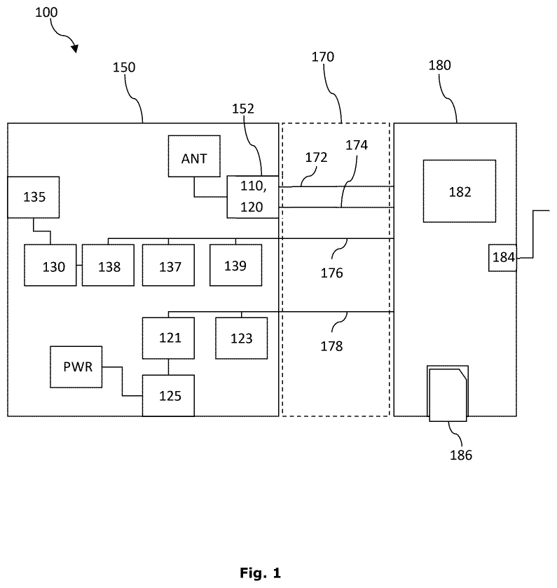

FIG. 1 shows schematically a block diagram of a gateway 100. The gateway 100 includes a first gateway module 150 and a second gateway module 180. The first gateway module 150 is a single PCB, including a first wireless communication component 110, a second wireless communication component 120 an Ethernet communication component 121 and a RS-232 communication component 130. The first wireless communication component 110 and the second wireless communication component 120 are provided in a single wireless communication element 152, which is connected to an antenna element ANT. The antenna element is a dual band antenna (e.g. 2.4 GHz and 5 GHZ), which is provided as an on board antenna of the PCB.

The second gateway module 180 is a single board computer, such as a Raspberry Pi, or a system on module. Further first and second modules 150, 180 are connected via a multi-pin connector 170. The multi-pin connector 170 enables communication between the modules 150, 180. Further, the multi-pin connector 170 may serve for powering.

In the embodiment shown in FIG. 1, the multi-pin connector includes a SDIO-interface 172, a UART-interface 174, an I2C-bus 176 and a SPI-interface 178. The SDIO-interface 172 and the UART-interface 174 are assigned to the wireless communication element 152, which accommodates the first wireless communication component 110 and the second wireless communication component 120.

The first wireless communication component 110 may be a Bluetooth communication component, which is adapted to establish a Bluetooth communication link, particularly Bluetooth LE, with at least one wearable user device. Further, the first wireless communication component 110 may be connected via the UART-interface 174 with the second gateway module 180. Thus, Bluetooth communication can be established via the first gateway module 150 and controlled via the second gateway module 180.

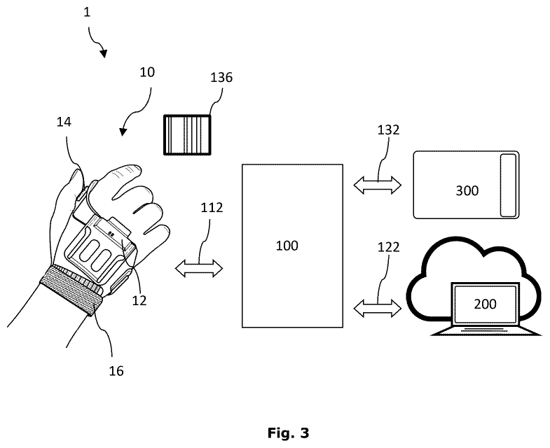

The second wireless communication component 120 may be a Wi-Fi communication component, which is adapted to establish a Wi-Fi communication link (e.g. Wi-Fi 6), with a control unit 200 (cf. FIG. 3). Further, the second wireless communication component 120 may be connected via the SDIO-interface 172 with the second gateway module 180. Thus, Wi-Fi communication can be established via the first gateway module 150 and controlled via the second gateway module 180.

Further an Ethernet communication component 121 may be provided. The Ethernet communication component 121 may be adapted to establish a wired (LAN) communication link with the control unit 200 (cf. FIG. 3). Further, the Ethernet communication component 121 may be connected via the SPI-interface 178 with the second gateway module 180. Thus, the wired communication can be established via the Ethernet communication component 121 and controlled via the second gateway module 180. In a particular aspect, a memory 123, such as a NOR flash memory, may be assigned to the Ethernet communication component 121. Further, the Ethernet communication component 121 may include a RJ45 port 125. The RJ145 may be configured for powering the gateway 100 (PoE).

Still further, the gateway 100 includes a RS-232 communication component. The RS-232 communication component 130 is configured to establish a RS-232 communication link 132 between the gateway 100 and at least one end device 300 (cf. FIG. 3).

The RS-232 communication component 130 includes a RJ12 port 135. Said RJ12 port may be configured for data transmission and for powering the gateway 100. The RS-232 communication component 130 is connected via a UART serial device 138 to an I2C-bus 176. The I2C bus serves for communication with the second gateway module 180. The I2C bus may be used for controlling further components of the gateway, such as an LED driver 137. Even further, a crypto and/or authentication component may be provided for providing an encrypted RS-232 communication and/or a respective authentication.

The second gateway module 180 may include a USB communication component 184. The USB communication component 184 may serve for powering the gateway 100 and/or for communication (data transmission) with further end device(s).

The communication between the gateway 100 and a control unit (i.e. via the second wireless communication component 120 and/or the Ethernet communication component 121) and the communication between the gateway 100 and an end device (i.e. via the RS-232 communication component 130 and/or the USB communication component 184) can be done simultaneously.

Still further, the second gateway module 180 includes a MCU 182 and a storage device 186, such as a flash memory, particularly a SD-card.

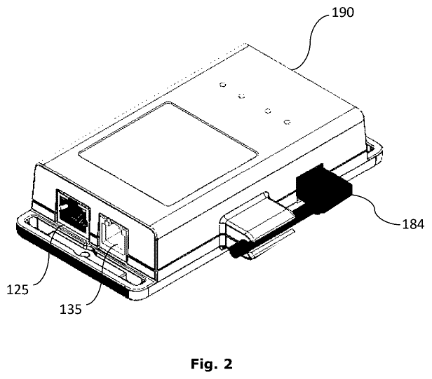

As shown in FIG. 2, the gateway 100 may be provided in housing 190. The housing may have a height in a range between 20 to 30 mm, or from 22 mm to 28 mm or about 25 mm. Further, the housing may have a width in a range between 60 to 95 mm, or from 65 mm to 85 mm or from 70 mm to 80 mm, or about 77 mm. Even further, the housing may have a length in a range between 100 to 140 mm, or from 110 mm to 135 mm or from 120 mm to 130 mm, or about 125 mm.

As shown in FIG. 2, the gateway 100 has a RS-232 communication component including a RJ12 port 135. Further the gateway 100 has an Ethernet communication component 121 including a RJ45 port 125. Even further, the gateway 100 has an USB communication component 184 including a USB port. Either one of the RJ12, the RJ45 or the USB port may serve for powering the gateway 100.

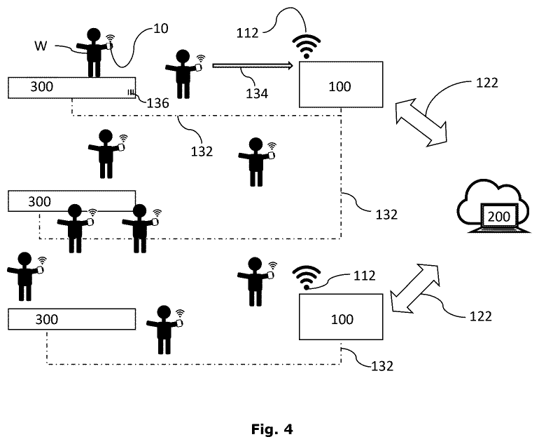

FIG. 3 shows schematically a control system 1. In FIG. 4 a more complex control system 1 is shown. The control system 1 includes at least one gateway 100, which may be configured as shown in FIG. 1.

The gateway 100 includes a first wireless communication component 110, which is configured to establish a first wireless communication link 112 (e.g. BT LE) between at least one wearable user device 10 and the gateway 100. As shown in FIG. 4, multiple gateways 100 may be part of the control system 1. Each gateway 100 may communicate via the first wireless communication link 112 with multiple wearable user devices 10.

The gateway 100 further includes a second wireless communication component (e.g. Wi-Fi) and/or an Ethernet communication component. The second wireless communication component and/or the Ethernet communication component is configured to establish at least one second communication link 122 between the gateway 100 and at least one control unit 200. As indicated in FIGS. 3 and 4, the control unit 200 may be cloud based.

Further, the gateway 100 includes a RS-232 communication component. The RS-232 communication component is configured to establish a third communication link 132 between the gateway 100 and at least one end device 300.

For configuring the RS-232 communication component, the wearable user device 10 may transmit configuration data 134 via the first communication link 112 to the gateway. Based on the configuration data 134, the gateway may configure at least the RS-232 communication component and establish the third communication link, accordingly.

The configuration data 134 may correspond to a configuration code 136, which is an optically readable configuration code, such as a barcode, particularly a one-dimensional barcode and/or a multi-dimensional barcode, a stacked code, a matrix code, a multicolour code, a QR code or suchlike.

The configuration code 136 can be captured via the wearable user device 10. Based on the captured configuration code 136 configuration data can be generated or provided. The wearable user device 10 includes at least one sensor 12 (e.g. a camera or a barcode scanner) for capturing the configuration code 136. For triggering the capturing, the wearable user device 10 may include an input means 14, such as a trigger. Further, the wearable user device 10 may be attached to a garment 16 (e.g. a cuff). This allows to easily wear the user device 10 (e.g. on a wrist or a back of one's hand).

The more complex control system 1 shown in FIG. 4 may be used to control a production and/or logistics process e.g. in a production site. The production site may include several end devices 300, such as assembly stations, intelligent storage locations, floor-borne vehicles, production machines and/or the like.

For example, a product may be manufactured in this production site and the production of said product must adhere to a predefined sequence comprising different process steps. The different process steps are executed by workers W at the different end devices 300, or assembly stations respectively.

Thus in production, the product passes through all end devices 300. For example, the product is a vehicle or parts therefore.

The control system 1 includes several wearable user devices 10, several gateways 100 as well as a cloud based, central control unit 200.

The user devices 10 are worn by the workers W. For example, each worker W wears at least one or more user devices 10.

The user devices 10 are connected in each case for communication with one of the gateways 100 via a first wireless communication link 112.

In turn, the gateways 100 are connected via a second (wired and/or wireless) communication link 122 with the control unit. Further, the gateways 100 may be in communication, via a third RS-232 communication link 132 with the end devices. USB-connection could also be used.

The communication links 112, 122, 132 allow communication between the wearable user device 10, the gateway(s) 100 and the control unit 200. The communication may be uplink and/or downlink. For configuring the gateway 100 and in particular the RS-232 communication component of the gateway, a worker may capture a configuration code 136. The configuration code may be provided at the end device 300 (e.g. as badge or print) or may be displayed on a graphical user interface of the end device 300. Thus, setting up the control system is facilitated.

For example, the gateways 100 may be located stationary in the production site. A specific area and/or end device of the production site is thus assigned to each gateway 100 so that a communication link exists between the user devices 10 of the workers W, who are working in this area or at the end device and the corresponding gateway 100.

The location or the area of the gateway 100 and the assigned end devices 300 can be stored for example in the central control unit 200. When setting up the gateways 100, this can be done by capturing the configuration code 136 with a wearable user device 10 that is connected to the gateway.

For operating the production site, the control unit 200 receives data from the user devices 10 and/or the end devices 300 and in response to this transmits control instructions back to the user devices 10 and/or the end devices 300. Thus, processing steps can be planned just in time, considering the present status of an end devices 300.

The control unit 200 may host an application, in which the sequence executed in the production site is stored (and adapted if need be) with all the individual process steps as well as the assignment of the process steps to the end devices 300. For example, the control unit 200 may be part of an inventory management system and/or an enterprise resource planning system (ERP system).

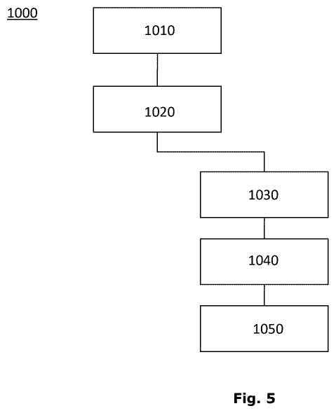

FIG. 5 shows a schematic flow chart of a method 1000 for configuring a control system 1. The control system 1 may be a control system as shown in FIG. 3 or 4. The method 1000 includes the following:
a) providing 1010 at least one configuration code 136 (e.g. an optical readable code, such as a barcode), wherein providing the at least one configuration code optionally includes generating the configuration code;
b) capturing 1020 the configuration code 136 with a wearable user device 10, which wearable user device 10 is assigned to a gateway 100;
c) transmitting 1030 configuration data 134 based on the configuration code 136 from the wearable user device 10 to the assigned gateway 100;
d) receiving the configuration data 134 and configuring 1040 the RS-232 communication component 130 of the gateway 100 based on the received configuration data 134;
e) establishing 1050 a third communication link 132 between the gateway 100 and at least one end device 300 for operating the control system 1.

Lists having a plurality of alternatives connected by “and/or”, for example “A, B and/or C” are to be understood to disclose an arbitrary combination of the alternatives, i.e. the lists are to be read as “A and/or B and/or C” or as “at least one of A, B or C”. The same holds true for listings with more than three items.

### LIST OF REFERENCE SIGNS

1 Control system
10 wearable user device
12 sensor
14 input means (trigger)
16 garment
100 gateway
110 first wireless communication component, e.g. Bluetooth
112 first communication link
120 second wireless communication component, e.g. Wi-Fi
121 Ethernet communication component
122 second communication link
123 memory
125 RJ45 port
130 RS-232 communication component
132 third communication link
134 configuration data
135 RJ12 port
136 configuration code
137 LED driver
138 UART serial device
139 Crypto and/or authentication component
150 first gateway module, e.g. a PCB
152 wireless communication element
170 multi-pin connector
172 SDIO-interface
174 UART-interface
176 I2C communication bus
178 SPI-interface
180 second gateway module, e.g. single board computer
182 Microcontroller, MCU
184 USB-communication component
186 storage device, e.g. SD-card
190 housing
200 control unit, e.g. cloud based
300 end device
W worker

1. A gateway for a control system, the gateway comprising:
a first wireless communication component, wherein
the first wireless communication component is configured to establish a first communication link between at least one wearable user device and the gateway, wherein the wearable user device includes a barcode scanner, and wherein the first communication link is a wireless communication link;
at least one of a second wireless communication component or an Ethernet communication component, wherein
the second wireless communication component and/or the Ethernet communication component is configured to establish at least one second communication link between the gateway and at least one control unit; and
a RS-232 communication component, wherein
the RS-232 communication component is configured to establish a third communication link between the gateway and at least one end device, wherein the third communication link is a wired RS-232 communication link, and wherein
the gateway is configured to configure at least the RS-232 communication component for establishing the third communication link based on configuration data received via the first communication link.

2. The gateway according to claim 1, wherein
the second and third communication links are configured to allow for a simultaneous communication between the gateway and the control unit as well as between the gateway and the at least one end device.

3. The gateway according to claim 1, wherein the configuration data include at least one of
instructions for configuring the gateway, including the RS-232 communication component, or
an identifier, wherein the identifier is linked to the instructions for configuring the gateway, including the RS-232 communication component.

4. The gateway according to claim 1, wherein
the first wireless communication component and the second wireless communication component are provided in a single wireless communication element, and/or wherein
the first wireless communication component may be a Bluetooth communication component, and
the second wireless communication component may be a Wi-Fi communication component.

5. The gateway according to claim 1, wherein
the RS-232 communication component includes a RJ12 port, being a RJ12 socket, wherein the RJ12 port may be configured for powering the gateway.

6. The gateway according to claim 1, wherein
the Ethernet communication component includes a RJ45 port, being a RJ45 socket, wherein the RJ45 port may be configured for powering the gateway.

7. The gateway according to claim 1, wherein
the gateway includes a first gateway module and a second gateway module being in communication with each other, wherein
the first gateway module includes the first wireless communication component, the second wireless communication component and/or the Ethernet communication component and the RS-232 communication component, wherein
the second gateway module is a single board computer or a system on module.

8. The gateway according to claim 7, wherein
the first gateway module and the second gateway module are connected via a communication link, including a multi-pin connector, and wherein the communication link includes at least one of
a SDIO-interface,
a UART-interface,
an I2C-bus, or
a SPI-interface.

9. The gateway according to claim 7, wherein
the first wireless communication component is connected via a UART-interface with the second gateway module; and/or wherein
the second wireless communication component is connected via a SDIO-interface with the second gateway module, and/or wherein
the Ethernet communication component is connected via a SPI-interface with the second gateway module.

10. The gateway according to claim 1, wherein
the RS-232 communication component is connected via a UART serial device to an I2C-bus.

11. The gateway according to claim 1, wherein the gateway further includes a USB-communication component, wherein the USB-communication component may be configured for receiving gateway configuration data and/or for powering the gateway.

12. A control system, the system comprising:
at least one gateway;
at least one wearable user device, wherein
the gateway includes
a first wireless communication component, wherein
the first wireless communication component is configured to establish a first communication link between the at least one wearable user device and the gateway, wherein the wearable user device includes a barcode scanner, and wherein the first communication link is a wireless communication link;
at least one of a second wireless communication component or an Ethernet communication component, wherein
the second wireless communication component and/or the Ethernet communication component is configured to establish at least one second communication link between the gateway and at least one control unit; and
a RS-232 communication component, wherein
the RS-232 communication component is configured to establish a third communication link between the gateway and at least one end device, wherein the third communication link is a wired RS-232 communication link, and wherein
the gateway is configured to configure at least the RS-232 communication component for establishing the third communication link based on configuration data received via the first communication link, and wherein
the wearable user device includes at least one sensor, the sensor being configured to capture at least one configuration code, wherein the wearable user device is configured to transmit configuration data based on the configuration code via the first communication link to the gateway.

13. The control system according to claim 12, wherein
the configuration code includes the configuration data, and/or wherein
the configuration code includes an identifier, the identifier being linked to the configuration data.

14. The control system according to claim 12, further including at least one of a control unit or an end device, wherein the control unit and/or the end device includes
a TCP server,
a MQTT server, and/or
is cloud based.

15. The control system according to claim 12, wherein the sensor is barcode scanner.

16. The control system according to claim 12, wherein the wearable user device is attached to a garment using a holder.

17. The control system according to claim 12, wherein the first communication link is a Bluetooth communication link.

18. The control system according to claim 12, wherein the gateway is configured to connect at least two wearable user devices, or at least five wearable user devices, or at least eight wearable user devices, or at least 10 wearable user devices.

19. A method for configuring a control system, the control system being configured according to claim 12, wherein the method comprises a steps of:
providing at least one configuration code, wherein
providing the at least one configuration code, optionally includes generating the configuration code;
capturing the configuration code with a wearable user device, which wearable user device is assigned to a gateway;
transmitting configuration data based on the configuration code from the wearable user device to the assigned gateway;
receiving the configuration data and configuring the RS-232 communication component of the gateway based on the received configuration data;
establishing a third communication link between the gateway and at least one end device for operating the control system.
